(19) United States
(12) Patent Application Publication
(10) Pub. No.: US 2008/0023986 A1
(43) Pub. Date: Jan. 31, 2008

(54) SYSTEM FOR CONNECTING UNITS TO A TRUCK AND A DEVICE FORMING PART OF THE SYSTEM

(75) Inventors: Hans REGNELL, Ytterby (SE); Jens GUSTAFSSON, Goteborg (SE); Benny LILJEBLAD, Lerum (SE)

Correspondence Address: NOVAK DRUCE & QUIGG, LLP, 1300 EYE STREET NW, SUITE 1000 WEST TOWER, WASHINGTON, DC, 20005, US

(73) Assignee: VOLVO LASTVAGNAR AB, Goteborg (SE)

(21) Appl. No.: 11/306,683

(22) Filed: Jan. 6, 2006

Related U.S. Application Data
(63) Continuation of application No. PCT/SE2004/001076, filed on Jul. 2, 2004.

(30) Foreign Application Priority Data
Jul. 8, 2003 (SE) 0302013-8

(51) Int. Cl. B62D 33/02

(52) U.S. Cl. 296/182.1; 296/187.11; 296/3

(57) ABSTRACT

A system for attaching a superstructure to a goods vehicle, provided with a chassis frame having longitudinal main beams (4, 5). Each of these is provided with a beam part (12) extending in a vertical direction with side surfaces (21). The system includes attaching devices (17, 18) associated with the chassis frame, arranged on each main beam, and also attaching devices (30) belonging to the superstructure (11). The attaching device of the chassis frame consists of a longitudinal attachment section (17, 18) attached to each main beam (4, 5) by fixing elements, the attachment sections having a longitudinal vertical fixing part (19) by which the attachment section is permanently attached to one side surface (21) of the respective main beam.

### CROSS-REFERENCE TO RELATED APPLICATIONS

The present application is a continuation patent application of International Application No. PCT/SE2004/001076 filed 02 Jul. 2004 which is published in English pursuant to Article 21(2) of the Patent Cooperation Treaty, and which claims priority to Swedish Application No. 0302013-8 filed 08 Jul. 2003. Said applications are expressly incorporated herein by reference in their entireties.

### TECHNICAL FIELD OF THE INVENTION

The present invention relates to a system for attaching a superstructure to a goods vehicle, and more particularly, to a vehicle that is provided with a chassis frame comprising longitudinal main beams, each having at least one beam part extending in a vertical direction, and with side surfaces.

### BACKGROUND OF THE INVENTION

The upper flange of the longitudinal frame members in the chassis of a goods vehicle is known for being used to attach superstructures to the incorporating vehicle. This means that the upper flange must be unimpeded and designed for such attachment and cannot be used for attaching other equipment that is associated with the goods vehicle. In addition, both the fixing devices on the frame members and on the superstructure must be designed specially to fit each other in each individual case, which imposes requirements relating to the planning of components in both the chassis and the superstructure, both during the development of new goods vehicles and during the development of new superstructures. For superstructures, this often involves welding which results in worse protection against corrosion and poor versatility.

### SUMMARY OF INVENTION

An object of the present invention is to produce a system and an arrangement that enables there to be greater freedom and versatility in the design and production of both goods vehicles and superstructures that are associated with such vehicles.

Another object is to enable there to be an optimizing of the durability of the frame of the vehicle in relation to weight and cost, independent of the attachment points on the superstructure. These objects are achieved by means of the systems and the arrangements exemplified herein and configured according to the teachings of the invention.

### BRIEF DESCRIPTION OF THE DRAWINGS

The invention will be described in greater detail in the following in the form of several embodiments, with reference to the attached drawings, in which:

FIG. 1 shows a partial perspective view of a first example of an arrangement configured according to the present invention for attaching a superstructure to a goods vehicle;

FIG. 2 shows a schematic rear view of the attachment arrangement of FIG. 1;

FIG. 3 shows a partial perspective view of a second example of an arrangement configured according to the present invention; and

FIGS. 4-9 show various variants of attachment arrangements that are configured according to the teachings of the present invention.

### DETAILED DESCRIPTION

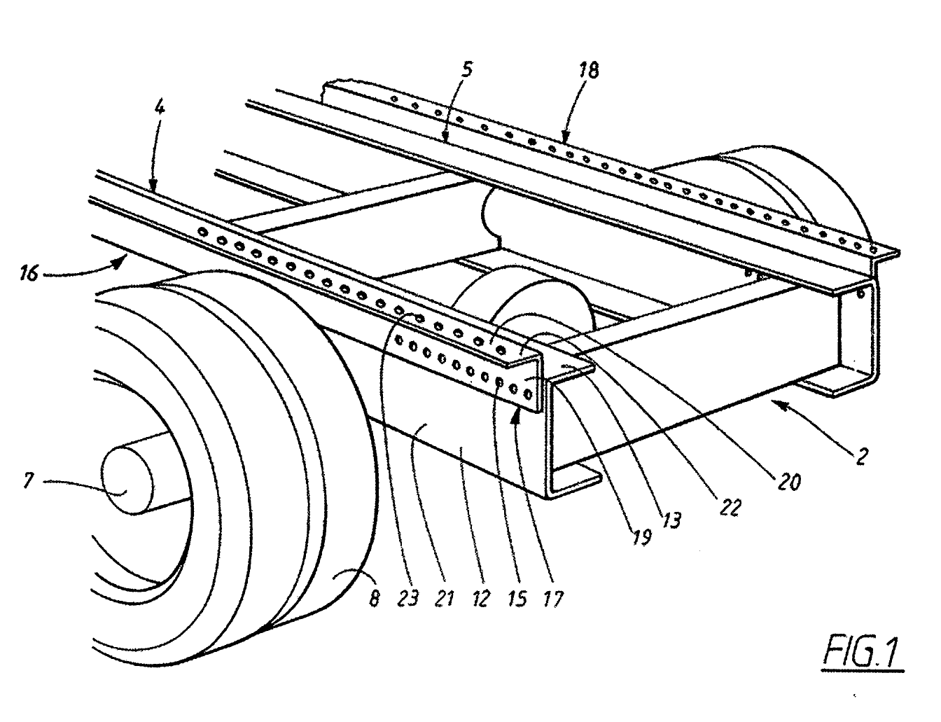

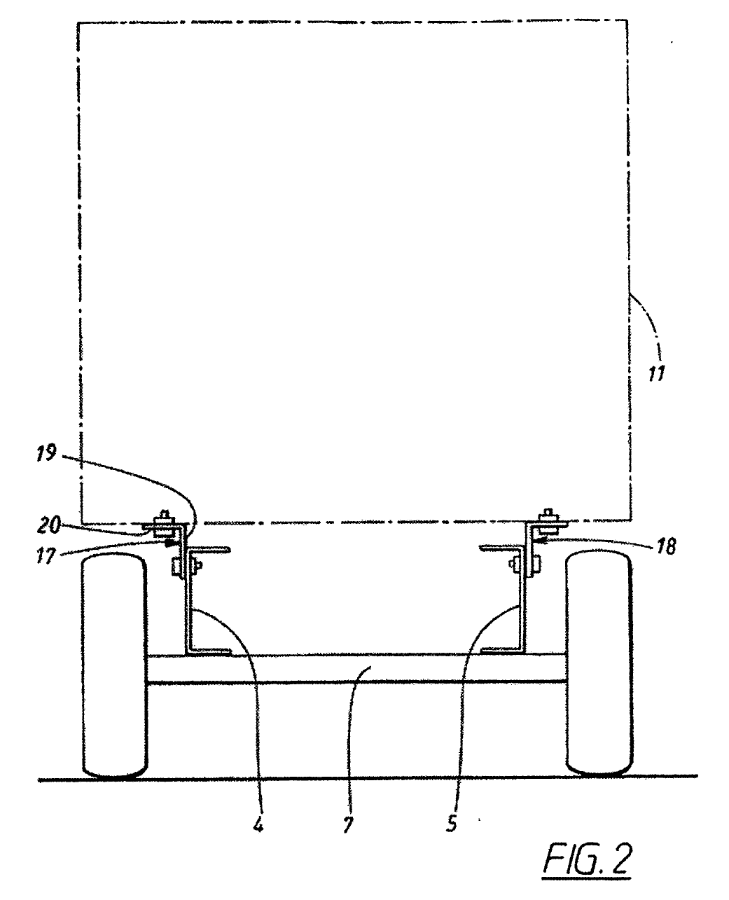

Firstly, the attachment system and the arrangement according to the invention will be described as a whole and in the form of a first embodiment with reference to FIGS. 1 and 2. The parts of a goods vehicle that are of importance in this connection are also shown and which have been developed and produced in their basic design by a goods vehicle manufacturer.

The goods vehicle consists essentially of a chassis 1 that in turn consists of a vehicle frame 2 and the least two wheel undercarriages 3 that support the vehicle frame. FIGS. 1 and 2 show the rear wheel undercarriage 3, and it will be understood that a front wheel undercarriage (not shown) supports the front part of the vehicle frame, which also supports a vehicle cab (not shown). The vehicle frame 2 has a number of longitudinal main beams 4, 5 (in the illustrated example, two in number) that extend essentially in a horizontal direction, and essentially parallel to each other, and which are joined together by means of a number of transverse frame members 6.

The wheel undercarriage has a wheel suspension (not shown) that supports the vehicle frame in such a way that it is sprung and can move relative to the wheel axle 7 upon which the vehicle's wheels 8, 9 rotate. The front wheel undercarriage, which is not shown, similarly supports the vehicle frame in such a way that it can move via a wheel suspension, with the wheels in the front undercarriage being steerable from the driver's seat in the cab of the vehicle. In some embodiments, the wheels in the rear wheel undercarriage can also be steerable. The wheels in the rear wheel undercarriage are driven by means of a driving motor (not shown) via a driveline (not shown).

The vehicle manufacturer thus produces the basic design described above, to which, however, there must be additions in order for the goods vehicle to achieve its final design, which can vary to a great extent depending upon the intended use of the goods vehicle concerned and the work it is to carry out. For this purpose, different types of superstructure are produced in the form of containers, or various types of devices, such as lifting devices and the like. These are usually produced by separate superstructure manufacturers who manufacture platform bodies, closed containers for general cargo or bulk loads, tanks for liquid loads, refuse collection vehicles with lifting devices, tipping devices and similar arrangements. In FIGS. 1 and 2, a superstructure in form of a box-shaped container 11 is shown schematically by chain-dotted lines.

In the example shown, the longitudinal frame members 4, 5 consist of channel sections, which are open inwards towards each other and have a vertical web 12, which forms a vertical beam part which, in cross-section, extends in a vertical direction, with an upper flange and a lower flange 13, 14 which, in cross-section, form beam parts extending in a horizontal direction. In addition to forming the frame of the goods vehicle, the longitudinal beams and their parts are used to support and attach various pieces of equipment which are comprised in the goods vehicle, such as hydraulics and pneumatics, fuel tank and associated pipes and hoses for the various systems. In addition, at the front the two frame members support the cab of the vehicle and the driving motor. In a standard version, the frame members are usually provided with a number of holes that have a predetermined standard layout, for example in one or several rows that can be used as required. For example, a longitudinal row of holes 15 can be arranged in the beam part 12.

According to the invention, the longitudinal frame members 4, 5 in the frame 2 of the vehicle support an attaching device 16 comprised in the attachment system in the form of a longitudinal section 17, 18 that is permanently attached to each main beam. In the example shown, each section consists of an angle section with a section part 19 extending essentially in a vertical direction and in the form of a fixing component permanently attached to the part 12 of the main beam that extends in a vertical direction, and an attachment part 20 extending in a sideways direction (in the example, essentially horizontally) that is intended to support and be attached to an attachment surface comprised in the attachment system on the superstructure 11. The attachment to the main beam is carried out by means of fixing elements, for example screw connections, rivet connections, fitted bolts or the like, via a plurality of holes in the fixing part 12, which can be arranged (positioned and dimensioned for example) to interact with holes 15 in the rows of holes in the part 12 of the main beams 4, 5.

More specifically, the fixing part 19 of the attachment section 17, 18 has a flat contact surface which is intended to make contact with the flat side surfaces 21 of the main beam extending in a sideways direction, in an outwards direction in the example shown. The part of the attachment section that extends in a sideways direction (that is, the attachment part 20) has a suitably flat supporting surface 22 that faces upwards. The supporting surface 22 is provided with at least one row of holes 23 along a length thereof in order to make possible a versatile attachment to selected predetermined holes or fixing elements in the attachment surface of the superstructure. Examples of such fixing elements include bolts with nuts or studs that are used to carry out the attachment or fixing of the superstructure concerned. The attachment between the superstructure and the attachment section 17, 18 can be carried out using other means, such as clamp connections. The attachment section 16 can extend over most of the length of the main beams 4, 5 in the form of a single unbroken length, or over several lengths, with or without gaps, or over one or more shorter lengths.

In the example of FIGS. 1 and 2, the attachment section projects upwards from the uppermost part 13 of the main beam and, as a result, this surface is completely unimpeded and an angled, protected space is created, for example for laying cables or hoses, and placing other components and the like. In addition, increased clearance is provided; that is, a larger space between the wheels and the superstructure is obtained.

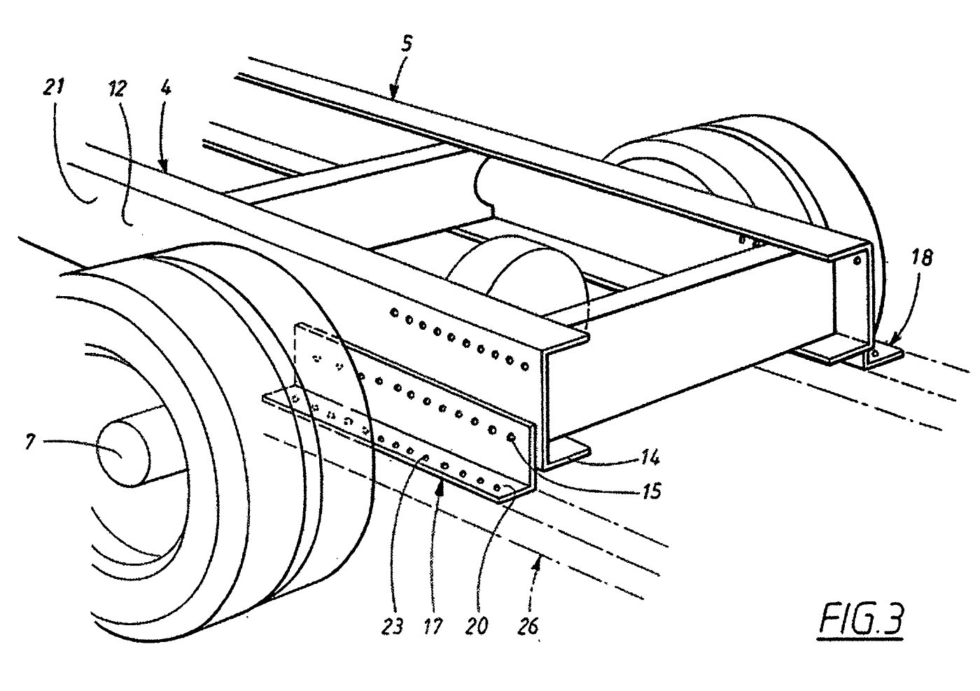

The example of FIG. 3 shows an alternative or supplementary position of the attaching device 16 in and attachment system that is configured according to the invention. In this example, sections 17, 18 of the same shape can be used, even though the length of the sections in the example is considerably shorter and extends essentially along the part of the beams 4, 5 that extends behind the rear wheel axle 7. In addition, the sections 17, 18 are reversed and attached to the lower edge of the main beams. The flange of the sections that extends in a sideways direction forms the attachment part 20 with an attachment surface for a part of a superstructure 26 that is arranged pointing backwards or at the back. This is indicated in the form of a fixing beam 26 which, in the example, is arranged on the underside of the flange 20 of the section that extends in a sideways direction, but can alternatively be located on its upper side. In both cases, the superstructure has attachment holes or fixing elements that are selected in advance, with a layout such that they fit in a number of holes selected from the existing holes 23 in the rows of holes in the flange, that is in the attachment part 20. In the case in question, the section projects downwards below the lower flange 14 of the main beam, but it can alternatively be on a level with this.

As another alternative, the flange 20 can be at a higher level than the lower edge of the main beam. In the embodiment according to FIG. 3, the attachment sections 17, 18 with their vertical fixing parts 19 are in contact with and are attached to the outside 21 of the beam part 12 as a result of the attachment sections having similarly a row of holes 15 for fixing elements, which similarly fit in corresponding holes in the lower parts of the main beam 4, 5. The attachment sections 17, 18, according to FIG. 3, can also extend in front of the wheel axles for special equipment.

By means of the embodiment according to FIG. 3, a superstructure can be attached at the back of a vehicle either separately or together with a superstructure that is supported by the frame members. Thus, on one and the same goods vehicle, sections can be arranged both above and below the main beams for attaching several superstructures. Examples of superstructures at the back can be lifting devices such as lifting platforms, cranes, lifting devices for rubbish bins on refuse collection vehicles, including those where a container constitutes a superstructure on the vehicle.

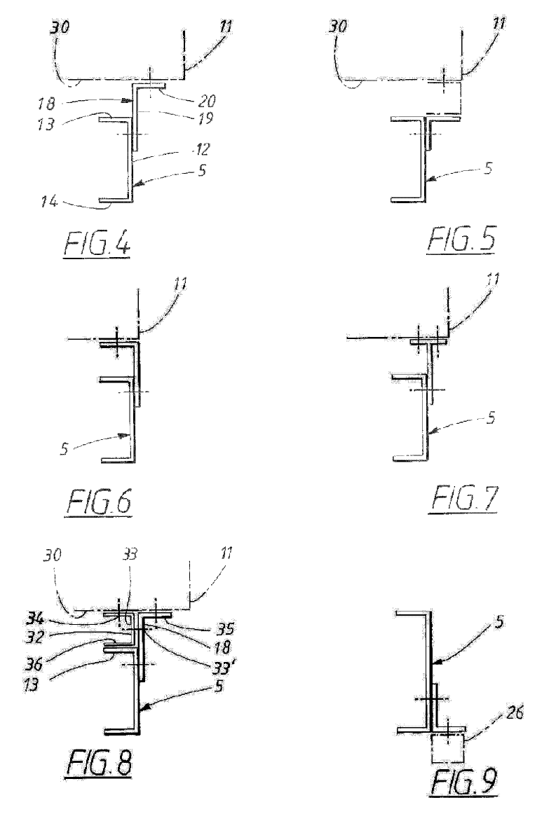

FIGS. 4-8 schematically show examples of different positions and designs of the attachment section, with FIG. 4 showing the embodiment described above in FIGS. 1 and 2. The attachment surface 30 or attaching device of the superstructure 11 constitutes a part of the attachment system according to the invention and can be a partial surface of the superstructure itself as indicated for instance in FIG. 4. Further, the attachment surface 30 can advantageously be a downwards facing surface of a flange 31 of a section, for example a channel section, permanently attached to the underside of the superstructure as shown in the example of FIG. 5. Two parallel attaching devices, such as sections, are here arranged on the superstructure 11 and have the same relative positions as the attaching devices on the goods vehicle, namely the sections 17, 18 and their holes 23.

FIG. 5 shows an attachment section in the form of an angle section, but with the attachment surface on a level with the upper flange 13 of the main beam, and FIG. 6 shows an attachment section, still in the shape of an angle section, but turned so that the attachment flange 20 is facing in the same direction as the upper and lower flanges 13, 14 of the main beam, that is facing inwards, whereby a particularly protected space 28 is created for laying cables and placing components and the like.

FIG. 7 shows an alternative embodiment in which the angle section is replaced by a T section that transfers the vertical load from the superstructure to the main beam in a more symmetrical way.

FIG. 8 shows an embodiment in which the angle section of FIG. 4 is supplemented by an inward-facing horizontal channel section 32. The web 33 is attached to the vertical part of the angle section by means of a fixing element 33′, while the upper flange 34 of the channel section forms a supplementary contact surface, which is located at the same level as the contact surface 35 of the angle section. The lower flange 36 is advantageously in contact with the upper flange 13 of the main beam 5, whereby the load from the superstructure 11 is transferred to the main beam via both sections. The channel section 32 can either be a part of the goods vehicle, that is a part of the attaching devices belonging to the chassis frame, or can be a part of the superstructure.

FIG. 9 shows an alternative embodiment with low positioning of the attachment section, which is shown in greater detail in FIG. 3. In the embodiment of FIG. 9, however, the angle section is positioned with its lower edge on a level with the flange 14 of the main beam 5.

It is thus common to all the embodiments that are shown and that are possible that a attachment system is created according to the invention in the form of an “interface” that provides a uniform predetermined design of both the goods vehicle chassis, without affecting the other constructional parts of the chassis, and of all the various superstructures, making possible a combined construction according to an agreed standard. In this way the superstructure manufacturers will only require instructions for each chassis version concerning the location of the attachment section on the goods vehicle; that is, layout and spacing of the rows of holes and the distance between the rows of holes between the parallel attachment sections. By means of this system, the goods vehicle can, in addition, be modified in a simple way or can be changed temporarily to another use. An example would be modification from a platform to a closed container, or the addition of lifting devices, without requiring special modifications to the main beams and thereby avoiding the risk of reduced chassis strength or interference with other installations.

What is claimed is:

1. A system for attaching a superstructure to a goods vehicle that is provided with a chassis frame comprising longitudinal main beams (4, 5) that are each provided with at least one beam part (12) extending in a vertical direction and having side surfaces (21), said system comprising:
chassis attaching devices (17, 18) configured to be associated with the chassis frame by arrangement on the main beams; and superstructure attaching devices (30) configured to be associated with a superstructure (11), said chassis attaching devices (17, 18) comprising at least one longitudinal attachment section (17, 18) configured to be attached to a main beam (4, 5) by fixing elements and said at least one longitudinal attachment section (17, 18) having a longitudinal vertical fixing part (19) by which said at least one longitudinal attachment section (17, 18) is permanently attached to a side surface (21) of a respective main beam.

2. The system as recited in claim 1, wherein the at least one longitudinal attachment section (17, 18) has a longitudinal horizontal attachment part (20) with an attachment surface (22) that faces one of upwards and downwards, said attachment surface (22) being provided with at least one row of attachment holes among which selected holes are useable for different types of superstructure for attaching the respective superstructure to the goods vehicle, and said at least one longitudinal attachment section (17, 18) and associated attachment holes having positions that are specially selected for the system and with the attaching device (30) of the superstructure having corresponding positions that are specially selected for the system.

3. The system as recited in claim 1, wherein the at least one longitudinal attachment section (17, 18) is attached to an upper edge of the main beams (4, 5).

4. The arrangement as recited in claim 1, wherein the at least one longitudinal attachment section (17, 18) is attached to the lower edge of the main beams (4, 5).

5. The arrangement as recited in claim 1, wherein the at least one longitudinal attachment section (17, 18) is attached to an outside of the main beams (4, 5).

6. A device for attaching a superstructure to a goods vehicle, provided with a chassis frame comprising two longitudinal main beams (4, 5), each provided with at least one beam part (12) extending in a vertical direction with side surfaces (21), wherein a longitudinal attachment section (17, 18) is permanently attached to each main beam (4, 5) by means of fixing elements, the attachment sections having a longitudinal vertical fixing part (19) by means of which the attachment section is permanently attached to one side surface (21) of the respective main beam, and in that the attaching devices (30) associated with the superstructure (11) are arranged to be attached to the attachment section (17, 18) of the main beams (4, 5).

7. The arrangement as recited in claim 6, wherein the attachment section (17, 18) has a longitudinal horizontal attachment part (20) with an attachment surface (22) that faces upwards or downwards, which attachment surface is provided with at least one row of attachment holes, with selected holes being used for each type of superstructure for attaching the superstructure to the goods vehicle.

8. The arrangement as recited in claim 6, wherein the attachment sections (17, 18) are at least two in number and are arranged at a selected distance apart and in that the attachment holes (15) are arranged with a predetermined uniform layout.

9. The arrangement as recited in claim 8, wherein the attachment sections (17, 18) consist of one of angle sections, T-sections, and channel sections.

10. The arrangement as recited in claim 9, wherein the attachment part (20) of the sections (17, 18) is located with a attachment surface (22) thereof in a vertical position at a distance from the associated main beam.

11. The arrangement as recited in claim 8, wherein the attachment sections (17, 18) consist of a combination of angle sections, T-sections, and channel sections.

12. The arrangement as recited in claim 11, wherein the attachment part (20) of the sections (17, 18) is located with a attachment surface (22) thereof in a vertical position at a distance from the associated main beam.

13. The arrangement as recited in claim 8, wherein the attachment sections (17, 18) consist of one of angle sections, T-sections, and Z sections.

14. The arrangement as recited in claim 13, wherein the attachment part (20) of the sections (17, 18) is located with a attachment surface (22) thereof in a vertical position at a distance from the associated main beam.

15. The arrangement as recited in claim 8, wherein the attachment sections (17, 18) consist of a combination of angle sections, T-sections, and Z sections.

16. The arrangement as recited in claim 15, wherein the attachment part (20) of the sections (17, 18) is located with a attachment surface (22) thereof in a vertical position at a distance from the associated main beam.
